(19) United States
(12) Patent Application Publication
(10) Pub. No.: US 2025/0224220 A1
(43) Pub. Date: Jul. 10, 2025

(54) Tape Measure Housing with Extended Mouth and Finger Brake Opening

(71) Applicant: Stanley Black & Decker, Inc., New Britain, CT (US)

(72) Inventors: Hsiao-Ting WEN, Taichung City (TW); Kuan Chieh WANG, Taichung City (TW)

(21) Appl. No.: 18/862,829

(22) PCT Filed: Apr. 27, 2023
(86) PCT No.: PCT/US2023/020204

§ 371 Date: Nov. 4, 2024

(51) Int. Cl. G01B 3/1007; G01B 3/1005; G01B 3/1043; G01B 3/1056

(52) U.S. Cl. CPC G01B 3/1007; G01B 3/1043; G01B 3/1056; G01B 2003/1012; G01B 2003/103; G01B 2003/1038

(57) ABSTRACT

A tape measure includes a housing comprising first and second housing portions together defining a mouth, and separated by a seam; and a spool configured to be secured between the first and second housing portions, the spool containing a tape blade wound thereon and partially extending therefrom through the mouth, the tape blade terminating in a hook portion. The seam is formed both above the mouth and at a side of the mouth, such that a structure of the first housing portion extends at least substantially an entire width of the mouth, under the tape blade. The tape blade is biased to retract into the housing and wind around the spool, such that in a fully retracted position the hook portion abuts the structure of the first housing portion. In an extended position the tape blade is unwound from the spool such that the hook extends away from the mouth.

### CROSS-REFERENCE TO RELATED APPLICATIONS

This application is a 371 U.S. national stage application of international application PCT/US23/20204, filed Apr. 27, 2023 which claims the benefit of U.S. Provisional Application No. 63/336,728, filed on Apr. 29, 2022, the entire contents of which are hereby incorporated herein by reference.

### FIELD OF THE INVENTION

The present invention relates to tape measures of the type comprising a housing containing a coiled elongate flexible measuring tape which is extendable from, and automatically retractable back into, the housing.

### BACKGROUND

Conventional finger brake opening may form a weak point on a tape measure housing due to the relative lack of structure thereat. As such, dropping a tape measure at the juncture between a wear plate and a finger brake opening may cause breakage at the juncture due to transmission of forces pushing the tape mouth and finger brake defining structure into either the finger brake opening or the tape mouth opening, causing breaking of the structure. In such conventional tape measure, an existing seam splitting the tape mouth and finger brake defining structure may facilitate breakages at such structure when receiving an undesired impact. Among other things, the present disclosure improves upon known finger brakes on tape measures and known wear plates on tape measures.

### SUMMARY OF THE INVENTION

According to one aspect of this disclosure, a tape measure comprises a housing comprising a first housing portion and a second housing portion, the first housing portion and the second housing portion together defining a mouth, and separated by a seam. The tape measure also comprises a spool configured to be secured between the first housing portion and the second housing portion, the spool containing a tape blade wound thereon and partially extending therefrom through the mouth, the tape blade terminating in a hook portion. The seam is formed both above the mouth and at a side of the mouth, such that a structure of the first housing portion extends at least substantially an entire width of the mouth, under the tape blade. The tape blade is biased to retract into the housing and wind around the spool, such that in a fully retracted position the hook portion abuts the structure of the first housing portion. In an extended position the tape blade is unwound from the spool such that the hook extends away from the mouth.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. In one embodiment of the invention, the structural components illustrated herein are drawn to scale. It is to be expressly understood, however, that the drawings are for the purpose of illustration and description only, and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

### BRIEF DESCRIPTION OF THE DRAWINGS

Features of tape measures in accordance with one or more embodiments are shown in the drawings, in which like reference numerals designate like elements. The drawings form part of this original disclosure in which:

FIG. 1 illustrates a perspective view of an embodiment of a tape measure of the present disclosure, having an extended finger brake opening thereof;

FIG. 2 depicts an exploded perspective view of the embodiment of the tape measure of FIG. 1;

FIG. 3 illustrates an enlarged isolated exploded perspective view of a housing of the tape measure, showing portions of the finger brake defining structure associated with each of a first and second housing side; and

FIGS. 4A-4C illustrate isolated, enlarged and assembled views of another embodiment of a housing of a tape measure, showing portions of the finger brake defining structure associated with each of a first and second housing side.

### DETAILED DESCRIPTION OF THE ILLUSTRATED EMBODIMENT(S)

An aspect of this invention may comprise a tape measure that includes a finger brake opening that facilitates a user pressing on a portion of the blade through an opening in a housing of the tape measure. In particular, structure defining both a mouth of the tape measure and the finger brake opening (e.g., extending across the entirety of the tape blade) may be formed on one side of the housing, such that the common tape mouth and finger brake structure includes a seamless region thereat. In some embodiments, the structure may further define a wear plate that supports the mouth of the tape measure from which the measuring tape extends and against which a hook of the tape retracts.

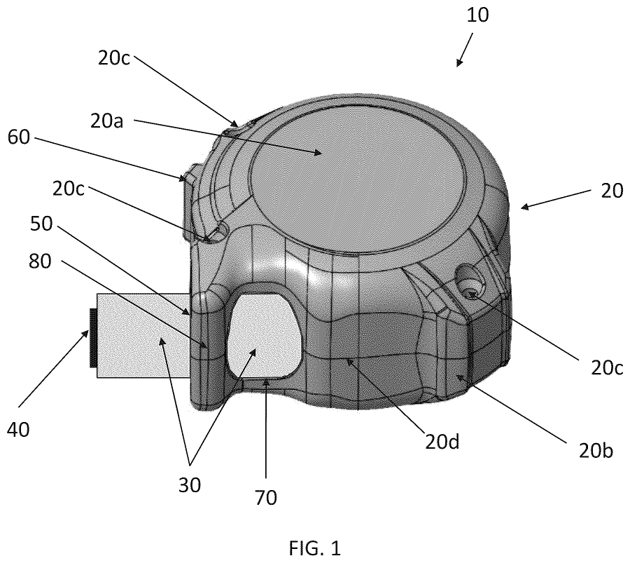

As shown in FIG. 1, a tape measure 10 may include a housing 20 containing a tape blade 30 which may terminate in a tape hook 40. The housing 20 may be made of any appropriate material, and typically may be formed from plastic, such as housing sides 20a and 20b that are joined together by fasteners 20c, such that the housing sides 20a and 20b have a defined seam 20d therebetween. In an embodiment, the seam 20d may generally bisect the tape measure housing 20, except as otherwise described herein. The tape blade 30 may extend from and retract into a mouth 50 of the tape measure 10. The tape blade 30 may be spring or otherwise automatically retractable into the housing 20. The tape hook 40 may prevent the tape blade 30 from being pulled completely into the housing 20, by abutting against surrounding structure of the mouth 50, as described in greater detail below. A locking mechanism, such as a slide lock 60, may also selectively clamp the tape blade 30, such as into an extended position protruding from the mouth 50. As further shown in the illustrated embodiment, a finger brake opening 70 may expose a generally flat expanse of the tape blade 30 and facilitate a user using their finger to press the blade 30 against the housing 20 or other internal features of the tape measure 10, so as to prevent automatic retraction of the tape blade 30 into the housing 20 without separate actuation of the slide lock 60 or similar locking mechanism.

It is an aspect of the present disclosure that the housing 20 includes the housing side 20a secured to the housing side 20b such that the seam 20d is formed therebetween, facilitating assembly of the housing 20 around a spool of the tape blade 30 therein. It is also an aspect of the present disclosure that a common tape mouth and finger brake structure 80 is formed with the housing side 20a, and is configured to extend across a width of the tape blade 30 so that the common tape mouth and finger brake structure 80 is generally seamless across width of the tape blade 30 thereat. Accordingly, the common tape mouth and finger brake structure 80 includes a seamless region thereat includes a seamless region, where the seam 20d between the housing side 20a and the housing side 20b extends at a side of the width of the tape blade 30 at the common tape mouth and finger brake structure 80. In some embodiments, it may be understood that a portion of the common tape mouth and finger brake structure 80 may be reinforced to act as a wear plate, which may prevent excessive wear to the mouth 50 or to the hook 40 as the hook 40 repeatedly is biased into the mouth 50 when the blade 30 is automatically retracted. The common tape mouth and finger brake structure 80 is described in greater detail below.

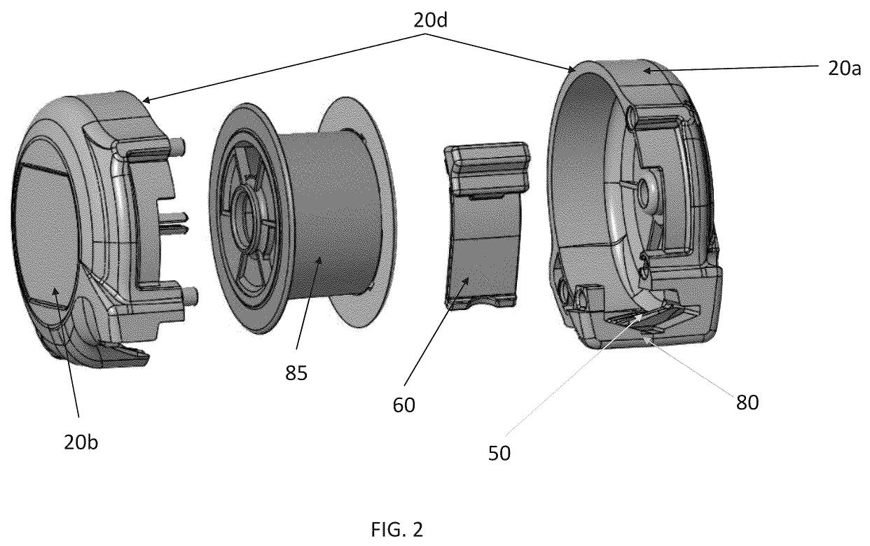

As seen in greater detail in FIG. 2, depicting an exploded view of notable components of the tape measure 10, the housing 20 may be separated at the seam 20d by removal of the fasteners 20c (not shown) that would normally be inserted into one of housing side 20a and housing side 20b, and extend across the seam 20d to secure the housing side 20a to the housing side 20b. As further shown, contained within the housing 20 may be the slide lock 60 in some embodiments. Other embodiments of the tape measure 10 may utilize other locking mechanisms to selectively lock the tape blade 30 (omitted in FIG. 2) in an extended position, such as an auto-lock feature. In the illustrated embodiment, a tape spool 85 is further shown, around which the tape blade 30 may be wound. The tape spool 85 may include therein a spring and function as a tape motor to facilitate auto-retraction of the tape blade 30 when the tape blade 30 is extended from the mouth 50.

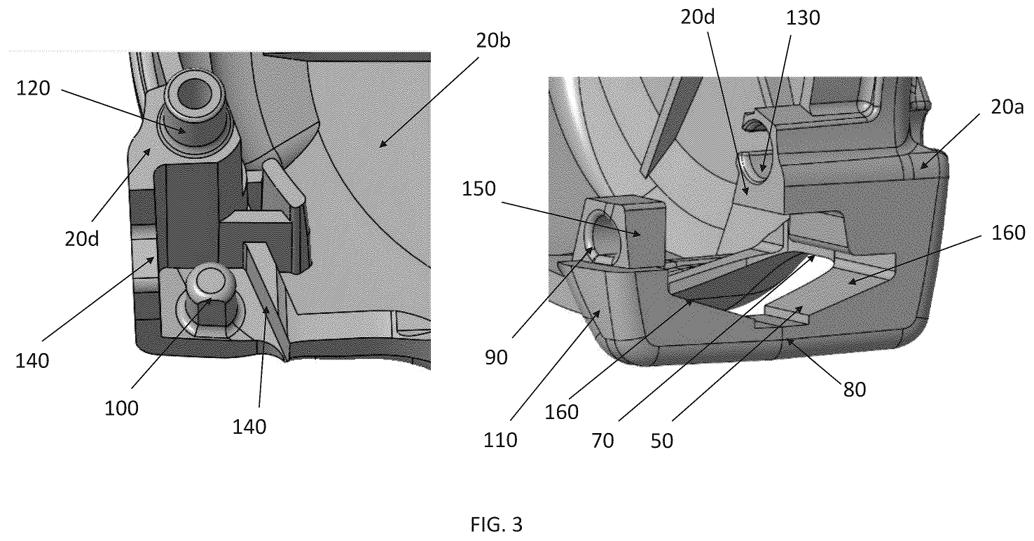

Turning to FIG. 3, the common tape mouth and finger brake structure 80 may be appreciated in greater detail. As shown in the enlargements of the housing side 20a and housing side 20b facing one another, the common tape mouth and finger brake structure 80 may be formed on the first housing side 20a and extend under at least substantially the entire width of the mouth 50 that permits extension of the tape blade 30 therethrough.

As shown, in an embodiment an engagement feature 90 may be formed on an end of the structure 80 distal from the bulk of the housing side 20a, and may engage an engagement feature 100 formed on the housing side 20b. In the illustrated embodiment the engagement feature 90 formed on the structure 80 of the housing side 20a is a recess, while the engagement feature 100 on the housing side 20b is a protrusion that is received in the recess of engagement feature 90. In other embodiments, the engagement feature 90 may be a protrusion while the engagement feature 100 is a recess.

As further shown, in an embodiment a terminal side 110 of the structure 80 may define the exterior of the housing side 20a thereat that substantially faces a same direction as an exterior of the housing side 20b. As such, the structure 80 may define a portion of both of opposing sides of the housing 20 (e.g., the side formed by housing side 20a and the side substantially formed by the housing side 20b).

Further shown in FIG. 3 are other housing side engagement features, such as the protrusion 120 and the recess 130. In the illustrated embodiment, the protrusion 120 is formed on the housing side 20b and is received in the recess 130 formed on the housing side 20a. it may be appreciated that both the protrusion 120 and the recess 130 may include an aperture that forms a common path for the fasteners 20c to be inserted in one side and extend and secure to the other. It may be appreciated that the positioning of the protrusion 120 and recess 130 may be inverted across the housing sides 20a and 20b. It may also be appreciated that other inter-engaging securement structures may be utilized in other embodiments.

It may be appreciated that the entirety of the housing side 20a including the entirety of the structure 80 may be formed from a single piece of material. For example, in an embodiment, the housing side 20a including the structure 80 may be formed of metal, such as a cast, stamped, or molded metal, a 3D printed metal, or formed in other such processes. In other embodiments, the housing side 20a including the structure 80 may be formed from plastic, such as 3D printed plastic, injection molded plastic, or formed in other such processes.

In some embodiments, the housing side 20b may include reinforcement structures 140 which may secure the region of the terminal side 110 including the engagement feature 90 into the housing side 20b, which may be supplementary to engagement between the engagement feature 90 on the side 20a and the engagement feature 100 on the side 20b. For example, in the illustrated embodiment, the region 150 formed on the terminal side 110 of the structure 80, and that includes the engagement feature 90 thereon, is formed with a recessed shape relative to the remainder of the terminal side 110, such that the region 150 is received inside the reinforcement structures 140 of the side 20b. It may be appreciated that such interlocking between the structure 80 and the housing side 20b may prevent undesired movement of the extension of the structure 80 across the mouth 50 (and at the front of the finger brake opening 70 adjacent thereto) and thus may deter breakage of the housing 20 thereat in the event of an unintended drop or striking impact of the tape measure 10.

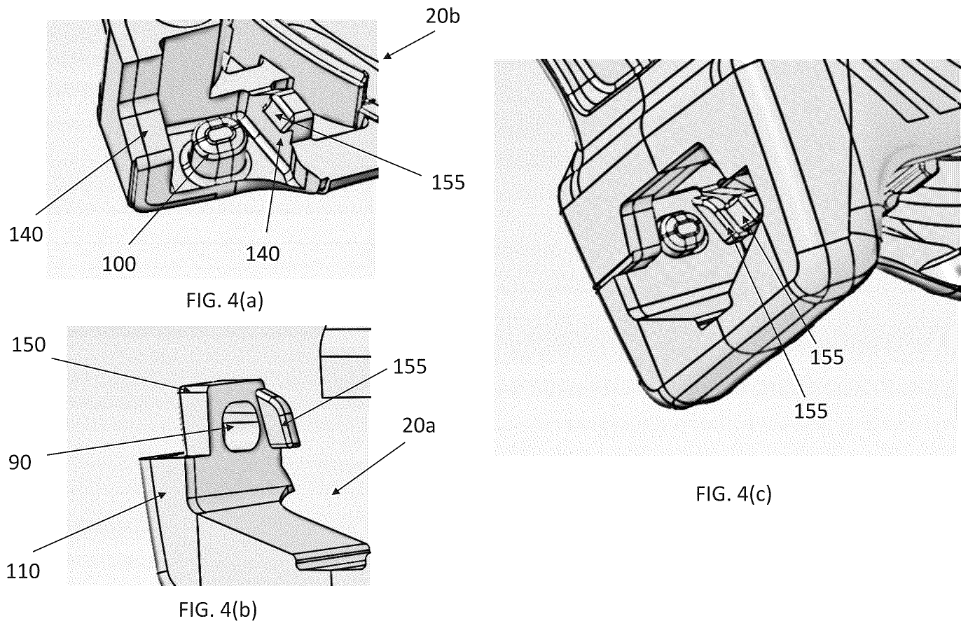

As shown in FIG. 4(a) and FIG. 4(b), in some embodiments the reinforcement structures 140 of the housing side 20a and the terminal side 110 of the structure 80 formed on the housing side 20a (e.g., at the region 150 thereof) may have securement features 155 thereat to further secure the housing side 20a to the housing side 20b at the structure 80. As shown, for example, in the illustrated embodiment a securement feature 155 on the housing side 20b (e.g., formed on the reinforcement structure 140) may engage with a securement feature 155 on the housing side 20a (e.g., formed on the region 150. In the illustrated embodiment, the securement features 155 comprise a snap fit engagement therebetween, as illustrated in FIG. 4(c), such that a ramped structure on one of the securement features 155 deflects or deforms around the other securement feature 155 then expands to retrain the securement feature 155 and deter unwanted separation of the housing side 20b and the housing side 20a. Other securement features 155 may alternatively or additionally be utilized, including but not limited to threaded fasteners, welds, or so on. It may be appreciated that such additional engagement through the securement feature 155 may prevent overall case deformation, and may close or eliminate gaps between the housing side 20a and the housing side 20b.

Returning to FIG. 3, In some embodiments the structure 80 may include blade guide features which may limit movement of the blade 30, so as to prevent rubbing of the blade 30 against the housing 20 as the blade 30 retracts. For example, the structure 80 includes blade guide features 160 defining parts of the mouth 50, which may match and support a contour of the blade 30, and/or may be configured to provide impact support strength to the component 80. In some embodiments, while a bottom of the mouth 50 is entirely defined by a shape of the structure 80, a top of the mouth 50 may be defined in part by the side 20a and in part by the side 20b. Similarly, it may be appreciated that a perimeter of the finger brake opening 70 may be defined at a front side entirely by the structure 80, at one side thereof entirely by the side 20a, and the other side entirely by the side 20b, and at a rear thereof by portions of the side 20a and the side 20b, with the seam 20d therebetween.

It may be appreciated that in various embodiments, the structures of inter-engaging features on the sides 20a and 20b described herein may be inverted from those described and illustrated, both in configuration and in position as described herein. While in the illustrated embodiment the securement of the housing sides 20a and 20b are through the described inter-engaging features, in other embodiments fasteners, adhesives, or other appropriate mechanisms may hold closed the seam 20d formed between the housing side 20a and the housing side 20b.

The objects, features, and characteristics of the present invention, as well as the methods of operation and functions of the related elements of structure and the combination of parts and economies of manufacture, may be apparent upon consideration of the description and drawings herein, all of which form a part of this specification. In one embodiment of the invention, the structural components illustrated herein are drawn to scale. It is to be expressly understood, however, that the drawings are for the purpose of illustration and description only and are not intended as a definition of the limits of the invention. In addition, it should be appreciated that structural features shown or described in any one embodiment herein can be used in other embodiments as well. As used herein, the singular form of “a”, “an”, and “the” include plural referents unless the context clearly dictates otherwise.

In various embodiments, tools and components thereof described herein may be formed of combinations of metal, plastic, ceramic, or any other appropriate material. It may be appreciated that the components described herein may be of different constructions or configurations, including but not limited to one or more being comprised of different material choices. For example, various components described herein may each be constructed from a variety of materials, including but not limited to one or more of fabrics, plastics, metals, rubbers, elastomers, or any other appropriate material choice, such as aluminum (e.g., machined aluminum), iron (e.g., steel), ceramic, or any other appropriate material. In addition to the components disclosed above, portions of tools leveraging the above teachings may be formed from molded or 3D printed plastic, metal, or combinations thereof (e.g., plastic with metal supports or fasteners coupling portions tougher). In some embodiments, structural and functional components may be formed from metal or hard plastic, while exterior-most gripped components positioned to engage the palm of a gripping hand to provide the palm with a comfortable gripping surface may be made of a suitable molded plastic material or elastomeric material, and may be generally formed as a bi-material suitable molded plastic material coated with a layer of an elastomeric material, such as a rubber-based material. In some embodiments, the material choices may differ from component to component. In various embodiments, some components may be integrally formed together, while other components may be assembled by any appropriate mechanism, including but not limited to fastened, welded, snap-fit, friction fit, adhesive bonding, or other appropriate securements.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of inventions more specifically understood in the context of the above disclosure.

What is claimed is:

1. A tape measure comprising:
a housing comprising a first housing portion and a second housing portion, the first housing portion and the second housing portion together defining a mouth, and separated by a seam; and
a spool configured to be secured between the first housing portion and the second housing portion, the spool containing a tape blade wound thereon and partially extending therefrom through the mouth, the tape blade terminating in a hook portion;
wherein the seam is formed both above the mouth and at a side of the mouth, such that a structure of the first housing portion extends at least substantially an entire width of the mouth, under the tape blade;
wherein the tape blade is biased to retract into the housing and wind around the spool, such that in a fully retracted position the hook portion abuts the structure of the first housing portion; and
wherein in an extended position the tape blade is unwound from the spool such that the hook extends away from the mouth.

2. The tape measure of claim 1, further comprising a finger brake opening formed between the first housing portion and the second housing portion.

3. The tape measure of claim 2, wherein the structure of the first housing portion that extends at least substantially the entire width of the mouth, under the tape blade, also defines a portion of the finger brake opening and forms a common tape mouth and finger brake structure.

4. The tape measure of claim 3, wherein the seam is formed behind the finger brake opening, extending away from both the mouth and the finger brake opening.

5. The tape measure of claim 1, further comprising a first engagement feature formed on one of the structure and the second housing side and a second engagement feature formed on the other of the structure and the second housing side, the first and second engagement feature shaped to engage at the seam at the side of the mouth.

6. The tape measure of claim 5, wherein the first engagement feature is a protrusion, and the second engagement feature is a recess.

7. The tape measure of claim 5 further comprising a third engagement feature formed on the first housing portion and a fourth engagement feature formed on the second housing portion, the third engagement feature and the fourth engagement feature shaped to engage at the seam above the mouth.

8. The tape measure of claim 7, wherein one of the third engagement feature and the fourth engagement feature is a protrusion, and the other of the third engagement feature and the fourth engagement feature is a recess.

9. The tape measure of claim 7, wherein the third engagement feature and the fourth engagement feature each comprise apertures that form a common path to receive a fastener that extends across the seam to secure the first housing portion and the second housing portion together.

10. The tape measure of claim 5, further comprising a reinforcement on a terminal end of the structure to interlock the structure to the second housing portion.

11. The tape measure of claim 10, wherein the reinforcement comprises a first securement feature.

12. The tape measure of claim 11, wherein the first securement feature comprises a ramped structure configured to deflect or deform around a second securement feature on the second housing portion to snap fit interlock the first securement feature to the second securement feature.

13. The tape measure of claim 1 further comprising a first engagement feature formed on the first housing portion and a second engagement feature formed on the second housing portion, the first engagement feature and the second engagement feature shaped to engage at the seam above the mouth.

14. The tape measure of claim 13, wherein one of the first engagement feature and the second engagement feature is a protrusion, and the other of the first engagement feature and the second engagement feature is a recess.

15. The tape measure of claim 13, wherein the first engagement feature and the second engagement feature each comprise apertures that form a common path to receive a fastener that extends across the seam to secure the first housing portion and the second housing portion together.

16. The tape measure of claim 1, wherein the structure extending under the tape blade adjacent to the mouth is shaped to match and support a contour of the tape blade.
